(19) United States
(12) Patent Application Publication
(10) Pub. No.: US 2020/0370893 A1
(43) Pub. Date: Nov. 26, 2020

(54) DEVICE AND METHOD FOR COMPENSATING FOR ROUTE OF AUTONOMOUS VEHICLE

(71) Applicants: Hyundai Motor Company, Seoul (KR); Kia Motors Corporation, Seoul (KR)

(72) Inventor: Dong Hoon Kang, Seoul (KR)

(21) Appl. No.: 16/564,919

(22) Filed: Sep. 9, 2019

(30) Foreign Application Priority Data
May 21, 2019 (KR) 10-2019-0059206

(51) Int. Cl. G01C 21/20; G01C 21/34; G06N 3/04; G05D 1/00; G05D 1/02; G08G 1/0968

(52) U.S. Cl. CPC G01C 21/20; G01C 21/3407; G08G 1/096827; G05D 1/0088; G05D 1/0212; G06N 3/04

(57) ABSTRACT

A device and a method for compensating a route of an autonomous vehicle are provided in which a normal route pattern for each section and abnormal route patterns for each section are learned based on a deep neural network (DNN). A compensated route pattern is obtained by changing a weighted value of each of a plurality of sensors for the abnormal route patterns for each section is learned, and the route of the autonomous vehicle is compensated based on the learning result to detect which sensor has an error when the route of the autonomous vehicle is abnormal.

### CROSS-REFERENCE TO RELATED APPLICATION

This application claims the benefit of priority to Korean Patent Application No. 10-2019-0059206, filed on May 21, 2019, the entire contents of which are incorporated herein by reference.

### TECHNICAL FIELD

The present disclosure relates to a technology for compensating for a route generated in the presence of an error in a sensor of an autonomous vehicle based on a deep learning, and more particularly, to a device and a method for compensating a route of an autonomous vehicle in which a normal route pattern for each section and abnormal route patterns for each section are learned based on a deep neural network.

### BACKGROUND

In general, a deep learning or deep neural network (DNN) is a type of a machine learning. The deep neural network includes Artificial Neural Network (ANN) having several layers between an input layer and an output layer. Such an artificial neural network may include a convolution neural network (CNN) or a recurrent neural network (RNN) based on a structure and a problem to be solved, a purpose, or the like.

The deep learning is used to solve various problems such as classification, regression, localization, detection, segmentation, or the like. In particular, in an autonomous driving system, semantic segmentation and object detection that may identify locations and types of dynamic and static obstacles are used significantly. The semantic segmentation refers to segmentation of an image into pixels having the same meaning, by performing a classification prediction on a pixel basis, to detect an object in the image. Thus, an object existing in the image and also positions of pixels having the same meaning (same object) may be identified more accurately.

The object detection refers to classifying and predicting types of objects in the image and performing a regress prediction on a bounding box to detect position information of the objects. Thus, unlike the simple classification, the types of the objects in the image and also the position information of the objects may be identified. In a conventional technology for compensating for a route of an autonomous vehicle, since the route is generated based on combined various sensor data, whether the route thus generated is normal or abnormal was able to be determined. However, in response to determining that the route is abnormal, it was difficult to detect which sensor has an error.

Further, in the conventional technology for compensating for a route of an autonomous vehicle, when the sensor with the error is detected, data from the sensor with the error is not excluded in a route generating process or a fixed weighted value is given to the data from the sensor with the error. Therefore, a route optimized for various driving environments such as curved road, circumvolution, or the like was not able to be provided.

### SUMMARY

The present disclosure provides a device and a method for compensating a route of an autonomous vehicle in which a normal route pattern for each section and abnormal route patterns for each section are learned based on a deep neural network (DNN), a compensated route pattern obtained by changing a weighted value of each sensor for the abnormal route patterns for each section is learned, and the route of the autonomous vehicle is compensated based on the learning result to detect which sensor has an error when the route of the autonomous vehicle is abnormal and routes optimized for various driving environments may be provided.

The technical problems to be solved by the present inventive concept are not limited to the aforementioned problems, and any other technical problems not mentioned herein will be clearly understood from the following description by those skilled in the art to which the present disclosure pertains. Further, it will be easily understood that the objects and advantages of the present disclosure may be realized by means of the means set forth in the claims and combinations thereof.

According to an aspect of the present disclosure, a device for compensating for a route of an autonomous vehicle may include a learning device configured to learn a first route pattern and second route patterns based on a state of each sensor at an arbitrary section and compensated route patterns for each weighted value of each sensor for each of the second route patterns, and a compensating device configured to detect a third route pattern based on a similarity between the second route patterns and a route generated by a route generating device based on a learning result of the learning device, detect a final compensated route pattern based on a similarity between compensated route patterns that corresponds to the third route pattern and the first route pattern, and transmit a weighted value of each sensor applied to the final compensated route pattern to the route generating device.

The first route pattern may be a route pattern generated when no error occurs in all of the sensors. When an error or malfunction occurs in the at least one of the sensors, the second route patterns may be generated for each error occurrence. The compensating device may be configured to detect the third route pattern based on the similarity between the second route patterns and the route generated by the route generating device in response to determining that the route generated by the route generating device is abnormal. The route generating device may be configured to generate a route based on the weighted value of each sensor transmitted from the compensating device. The first route pattern, the second route patterns, and the compensated route patterns may be extracted based on a deep neural network (DNN).

According to an aspect of the present disclosure, a method for compensating for a route of an autonomous vehicle may include learning a first route pattern and second route patterns based on a state of each sensor at an arbitrary section and compensated route patterns for each weighted value of each sensor for each of the second route patterns, detecting a third route pattern based on a similarity between the second route patterns and a route generated by a route generating device, detecting a final compensated route pattern based on a similarity between compensated route patterns that corresponds to the third route pattern and the first route pattern, and transmitting a weighted value of each sensor applied to the final compensated route pattern to the route generating device.

The first route pattern may be a route pattern generated when no error occurs in all of the sensors. When an error occurs in the at least one of the sensors, the second route patterns may be generated for each error occurrence. The detecting of the third route pattern may be performed in response to determining that the route generated by the route generating device is abnormal. The method may further include generating, by the route generating device, a route based on the weighted value of each sensor transmitted from the compensating device. The first route pattern, the second route patterns, and the compensated route patterns may be extracted based on a deep neural network (DNN).

According to an aspect of the present disclosure, a system for compensating for a route of an autonomous vehicle may include a plurality of sensors configured to collect various sensor data, a route generating device configured to generate a route of the autonomous vehicle based on the sensor data collected by the plurality of sensors, and a route compensating device configured to learn a first route pattern and second route patterns based on a deep neural network (DNN), learn compensated route patterns for each weighted value of each sensor for each of the second route patterns, and compensate the route of the autonomous vehicle based on the learning result. The route generating device may reflect weight values set by the route compensating device to the sensor data obtained from the plurality of sensors to generate the route.

Additionally, the route compensating device may include a learning device configured to learn a first route pattern and second route patterns based on a state of each sensor at an arbitrary section and compensated route patterns for each weighted value of each sensor for each of the second route patterns, and a compensating device configured to detect a third route pattern based on a similarity between the second route patterns and a route generated by a route generating device based on the learning result of the learning device, detect a final compensated route pattern based on a similarity between compensated route patterns that corresponds to the third route pattern and the first route pattern, and transmit a weighted value of each sensor applied to the final compensated route pattern to the route generating device.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a block diagram of a system for compensating for a route of an autonomous vehicle according to an exemplary embodiment of the present disclosure;

FIG. 2 is an explanatory diagram of a DNN executing module in a controller included in a device for compensating for a route of an autonomous vehicle according to an exemplary embodiment of the present disclosure;

FIG. 3 illustrates a block diagram of a device for compensating for a route of an autonomous vehicle according to an exemplary embodiment of the present disclosure;

FIG. 4 is a flowchart of a method for compensating for a route of an autonomous vehicle according to an exemplary embodiment of the present disclosure; and

FIG. 5 is a block diagram of a computing system for implementing a method for compensating for a route of an autonomous vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, some exemplary embodiments of the present disclosure will be described in detail with reference to the exemplary drawings. In adding the reference numerals to the components of each drawing, it should be noted that the identical or equivalent component is designated by the identical numeral even when they are displayed on other drawings Further, in describing the exemplary embodiment of the present disclosure, a detailed description of the related known configuration or function will be omitted when it is determined that it interferes with the understanding of the exemplary embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

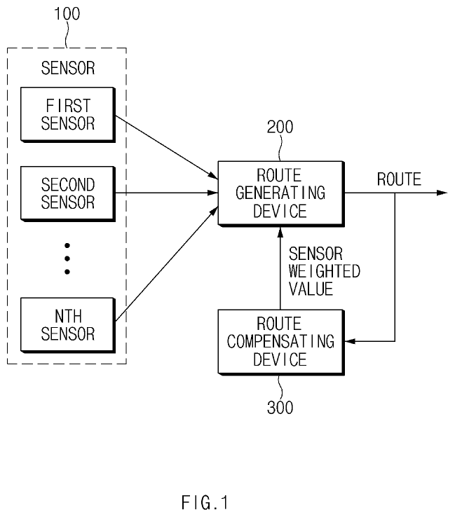

In one exemplary embodiment of the present disclosure, a sensor weighted value and a sensor data weighted value are used in the same concept. FIG. 1 illustrates a block diagram of a system for compensating for a route of an autonomous vehicle according to an exemplary embodiment of the present disclosure. As shown in FIG. 1, the system for compensating for the route of the autonomous vehicle according to one exemplary embodiment of the present disclosure may include a sensor 100, a route generating device 200, and a route compensating device 300. The various components of the system may be operated by an overall controller.

The respective components will be described in detail. First, the sensor 100 may be mounted in the autonomous vehicle to collect various sensor data necessary for generating a route for autonomous driving. In one example, the sensor 100 may include a LiDAR sensor, a camera sensor, an ultrasonic sensor, a laser sensor, an infrared sensor, and the like. For reference, the LiDAR (Light Detection And Ranging) sensor is a type of environmental recognition sensor. The LiDAR sensor may be configured to measure a position coordinate and the like of a reflector in a data format called a point cloud based on a time in which the LiDAR sensor shoots a laser in all directions while rotating and then the laser is reflected and returned. This LiDAR may be attached to an aircraft or a satellite to be used in a topographic survey, and may also be used in a mobile robot and the autonomous vehicle to detect obstacles.

The route generating device 200 may be configured to generate a route of the autonomous vehicle on a road based on data acquired from each sensor 100, precision map data, Global Positioning System (GPS) data, and the like. In other words, the route generating device 200 may be configured to generate the route after assigning weighted values set by the route compensating device 300 to the data acquired from each sensor 100. For example, when a weighted value for a first sensor data is about 50%, a weighted value for a second sensor data is about 30%, and a weighted value for a third sensor data is about 20%, the route generating device 200 reflects the first sensor data in a highest proportion and then sequentially reflects the second sensor data and the third sensor data in a route generating process. Accordingly, the route of the autonomous vehicle on the road varies based on which sensor data has a larger proportion.

For reference, a technology of generating the route based on the respective sensor data by the route generating device 200 is a generally well-known technology, and thus a detailed description will be omitted. The route compensating device 300 may be configured to learn a normal route pattern for each section and abnormal route patterns for each section based on a deep neural network (DNN), learn compensated route patterns obtained by changing the weighted value for each sensor for the abnormal route patterns for each section, and compensate the route of the autonomous vehicle based on the learning result.

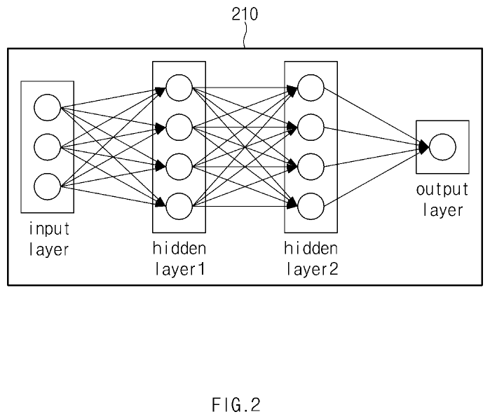

A compensating device 20 of the route compensating device 300 may include a DNN executing module 210 as shown in FIG. 2. FIG. 2 is an explanatory diagram of a DNN executing module in a compensating device included in a device for compensating for a route of an autonomous vehicle according to an exemplary embodiment of the present disclosure. As shown in FIG. 2, the DNN executing module 210 in the compensating device 20 included in the device for compensating the route of the autonomous vehicle according to one exemplary embodiment of the present disclosure learns route data for each section based on a state of each of the sensors generated in various driving environments and extracts the normal route pattern for each section and the abnormal route patterns for each section.

In addition, the DNN executing module 210 may be configured to learn the route data obtained by changing the weighted value of each of the sensors with respect to the abnormal route patterns for each section to extract a plurality of compensated route patterns that correspond to the abnormal route patterns for each section. In one exemplary embodiment of the present disclosure, it is described that the DNN executing module 210 may be provided in the compensating device 20 of the autonomous vehicle's route compensating device 300, but the DNN executing module 210 may be implemented as a separate component

Hereinafter, a process of learning the normal route pattern for each section and the abnormal route patterns for each section based on the DNN by the route compensating device 300 and a process of learning the compensated route pattern obtained by changing the weighted value of each the sensors with respect to the abnormal route patterns for each section by the route compensating device 300 will be described in detail.

First, as a process of learning the normal route pattern for each section, the route compensating device 300 may be configured to execute the DNN on a route generated by the route generating device 200 for each section to extract the normal route pattern for each section when all the sensors are in a normal state (e.g., no error, failure, or malfunction). In this connection, the DNN process is a well-known technology, and thus, detailed description will be omitted. Further, as a process of learning the abnormal route patterns for each section, when an error occurs in at least one of the plurality of sensors, the route compensating device 300 may be configured to execute the DNN on the route generated for each section by the route generating device 200 to extract the abnormal route patterns for each section.

For example, assuming a first sensor, a second sensor, and a third sensor, a route may be generated for each of a case in which an error occurred in the first sensor, a case in which an error occurred in the second sensor, a case in which an error occurred in the third sensor, a case in which errors occurred in the first sensor and the second sensor, a case in which errors occurred in the first sensor and the third sensor, and a case in which errors occurred in the second sensor and the third sensor. The DNN may be executed based on the route generated for each case to extract abnormal route patterns for each section. In this connection, the process of generating the route for executing the DNN may be performed at least once in various driving environments.

Next, the route compensating device 300 may be configured to obtain a plurality of compensated route patterns while changing the weighted value of each of the sensors with respect to the abnormal route patterns for each section. In this connection, the compensated route patterns may be generated by the route generating device 200 based on the weighted values set by the route compensating device 300. For example, the route compensating device 300 may be configured to generate a compensated route pattern while changing the weighted values for the first, second, and third sensors respectively when the error occurred in the first sensor among the first, second, and third sensors. Further, the route compensating device 300 may be configured to generate a compensated route pattern while changing the weighted values for the first, second, and third sensors respectively when the error occurred in the second sensor. Further, the route compensating device 300 may be configured to obtain a compensated route pattern while changing the weighted values for the first, second, and third sensors respectively when the error occurred in the third sensor.

As another example, the route compensating device 300 may be configured to generate a compensated route pattern while changing the weighted values for the first, second, and third sensors respectively when the errors occurred in the first and the second sensors among the first, second, third sensors. Further, the route compensating device 300 may be configured to generate a compensated route pattern while changing the weighted values for the first, second, and third sensors respectively when the errors occurred in the second and third sensors. The route compensating device 300 may also be configured to obtain a compensated route pattern while changing the weighted values for the first, second, and third sensors respectively when the errors occurred in the first and third sensors.

As a result, the route compensating device 300 may be configured to obtain the compensated route patterns by changing the weighted value of each of the sensors with respect to the abnormal route patterns for each section based on a failure state of each sensor. In this connection, the route compensating device 300 may be configured to learn the failure state of each sensor corresponding to each compensated route pattern and the weighted value of each of the sensors. The route compensating device 300 may also be configured to determine whether the route generated by the route generating device 200 is abnormal based on the normal route pattern and the abnormal route patterns.

In this connection, in a process of comparing the route generated by the route generating device 200 with the normal route pattern and the abnormal route patterns, a generally well-known similarity determination technology may be applied. When the similarity determination technology is applied thereto, the route compensating device 300 may be configured to determine that the route generated by the route generating device 200 is normal when the route with a highest similarity is the normal route pattern and determine the route generated by the route generating device 200 is abnormal when the route with a highest similarity is the abnormal route pattern.

In response to determining that the route generated by the route generating device 200 is abnormal, the route compensating device 300 may be configured to detect an abnormal route pattern having a highest similarity to the route generated by the route generating device 200. The route compensating device 300 may be configured to detect a compensated route pattern having a highest similarity to the normal route pattern among the compensated route patterns that correspond to the detected abnormal route patterns and detect the weighted values for respective sensors applied to the detected compensated route pattern.

The route compensating device 300 may then be configured to transmit the detected weighted value of each of the sensors to the route generating device 200. Further, the route generating device 200 may apply the corresponding weight value to each of the sensors to generate a route. The route thus generated will have a normal route pattern. As a result, even when an error occurred in the sensor 100, the route generating device 200 may be configured to generate a normal route due to the weighted value of each sensor set by the route compensating device 300.

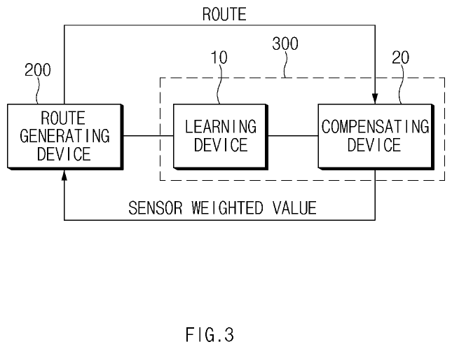

FIG. 3 illustrates a block diagram of a device for compensating for a route of an autonomous vehicle according to an exemplary embodiment of the present disclosure. As shown in FIG. 3, the autonomous vehicle's route compensating device 300 according to one exemplary embodiment of the present disclosure may include a learning device 10 and the compensating device 20. In this connection, the respective components may be combined with each other to be implemented as a single component or some components may be omitted based on a manner to implement the autonomous vehicle's route compensating device 300 according to one exemplary embodiment of the present disclosure. In other words, the learning device 10 and the compensating device 20 may be implemented as a controller and as a single component.

In this connection, the controller may be implemented in hardware or software, or in a combination thereof. Preferably, the controller may be implemented in a microprocessor, but is not limited thereto. The controller may be configured to learn the normal route pattern for each section and the abnormal route patterns for each section based on the DNN, learn the compensated route patterns obtained by changing the weighted value of each of the sensors with respect to the abnormal route patterns for each section, and perform various controls required in the process of compensating the route of the autonomous vehicle based on the learning result.

The respective components will be described in detail. First, the learning device 10 may be configured to learn the normal route pattern (e.g., a first route pattern) for each section and the abnormal route patterns (e.g., a second route patterns) for each section based on the DNN (Deep Neural Network) and learn the compensated route patterns obtained by changing the weighted values of each of the sensors for the abnormal route patterns for each section.

The normal route pattern for each section and the abnormal route patterns for each section based on the state of each sensor and the compensated route patterns that correspond to the above-mentioned abnormal route patterns for each section extracted via the above-mentioned learning process may be stored in storage (not shown). The storage may further be configured to store weighted value information (value) of each sensor corresponding to each compensated route pattern.

Particularly, the storage may be configured to store various logic, algorithms, and programs required in the above-mentioned learning process. The storage may include at least one type of a storage medium of at least one type of memory such as a flash memory type, a hard disk type, a micro type, and a card type (for example, an SD card (Secure Digital Card) or an XD card (eXtream Digital Card)) memory, and the like, and a RAM (Random Access Memory), SRAM (Static RAM), ROM (Read Only Memory), PROM (Programmable ROM), EEPROM (Electrically Erasable PROM), MRAM (Magnetic RAM), a magnetic disk, and an optical disk type memory.

The compensating device 20 may then be configured to determine whether the route generated by the route generating device 200 is normal or abnormal based on the learning result (in one example, the normal route pattern and the abnormal route patterns) of the learning device 10. In other words, the compensating device 20 may be configured to compare the route generated by the route generating device 200 with the normal route pattern and the abnormal route patterns. When the route pattern having a highest similarity is the normal route pattern, the compensating device 20 may be configure to determine that the route generated by the route generating device 200 is normal. When the route pattern having a highest similarity is the abnormal route pattern, the compensating device 20 may be configured to determine that the route generated by the route generating device 200 is abnormal.

At this time, after primarily comparing the route generated by the route generating device 200 with the normal route pattern, when the similarity therebetween does not exceed a threshold (e.g., 80%), the compensating device 20 may be configured to determine that the route generated by the route generating device 200 is abnormal and may be configured to secondarily compare the route generated by the route generating device 200 with the abnormal route patterns stored in the storage. In response to determining that the route generated by the route generating device 200 is abnormal, the compensating device 20 may be configured to detect the abnormal route pattern (e.g., a third route pattern) having a highest similarity to the route generated by the route generating device 200 among the abnormal route patterns

The compensating device 20 may be configured to detect a final compensated route pattern having a highest similarity to the normal route pattern (the first route pattern) among the compensated route patterns that correspond to the detected abnormal route pattern (the third route pattern) and detect the weighted value of each sensor applied to the detected final compensated route pattern. The compensating device 20 may then be configured to transmit the detected weighted value of each sensor to the route generating device 200. Accordingly, the route generating device 200 may be configured to generate the route based on the weighted value information of each sensor transmitted from the compensating device 20 and the route thus generated will have the normal route pattern.

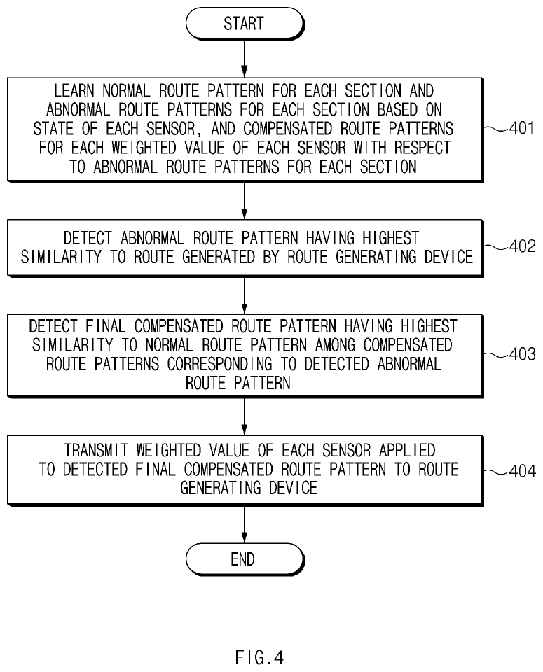

FIG. 4 is a flowchart of a method for compensating for a route of an autonomous vehicle according to an exemplary embodiment of the present disclosure. First, the learning device 10 may be configured to learn the normal route pattern for each section and the abnormal route patterns for each section based on the state of each sensor, and the compensated route patterns for each weighted value of each sensor with respect to the abnormal route patterns for each section (401). In other words, the learning device 10 may be configured to learn, at an arbitrary section, the first route pattern and the second route patterns based on the state of each sensor at each section and the compensated route patterns for each weighted value of each sensor for each of the second route patterns.

Thereafter, the compensating device 20 may be configured to detect the abnormal route pattern having a highest similarity to the route generated by the route generating device 200 based on the learning result of the learning device 10 (402). In other words, the compensating device 20 may be configured to detect the third route pattern having a highest similarity to the route generated by the route generating device 200.

Thereafter, the compensating device 20 may be configured to detect the final compensated route pattern having a highest similarity to the normal route pattern among the compensated route patterns that correspond to the detected abnormal route pattern (403). In other words, the compensating device 20 may be configured to detect the final compensated route pattern having a highest similarity to the first route pattern among the compensated route patterns that correspond to the detected third route pattern. Thereafter, the compensating device 20 may be configured to transmit the weighted value of each sensor applied to the detected final compensated route pattern to the route generating device 200 (404).

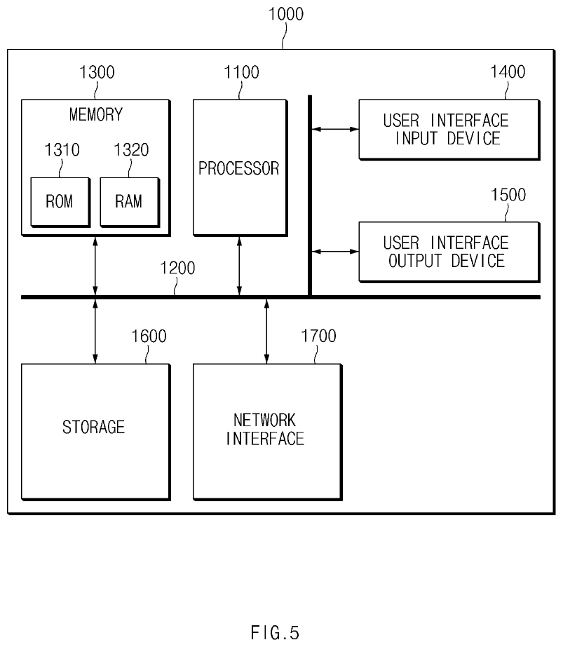

FIG. 5 is a block diagram of a computing system for implementing a method for compensating for a route of an autonomous vehicle according to an exemplary embodiment of the present disclosure. Referring to FIG. 5, the method for compensating for the route of the autonomous vehicle according to one exemplary embodiment of the present disclosure described above may also be implemented via a computing system. A computing system 1000 may include at least one processor 1100, a memory 1300, a user interface input device 1400, a user interface output device 1500, storage 1600, and a network interface 1700 connected via a system bus 1200.

The processor 1100 may be a central processing unit (CPU) or a semiconductor device configured to perform processing on instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory). Thus, the operations of the method or the algorithm described in connection with the exemplary embodiments disclosed herein may be embodied directly in a hardware or a software module executed by the processor 1100, or in a combination thereof. The software module may reside on a storage medium (that is, the memory 1300 and/or the storage 1600) such as a RAM, a flash, a ROM, an EPROM, an EEPROM, a register, a hard disk, a solid state drive (SSD), a removable disk, a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal

In the device and the method for compensating the route of the autonomous vehicle according to one exemplary embodiment of the present disclosure, the normal route pattern for each section and the abnormal route patterns for each section are learned based on the DNN (Deep Neural Network), a compensated route pattern obtained by changing a weighted value of each sensor for the abnormal route patterns for each section may be learned, and the route of the autonomous vehicle may be compensated based on the learning result to detect which sensor has an error when the route of the autonomous vehicle is abnormal.

Further, in the device and the method for compensating the route of the autonomous vehicle according to one exemplary embodiment of the present disclosure, the normal route pattern for each section and the abnormal route patterns for each section may be learned based on the DNN (Deep Neural Network), a compensated route pattern obtained by changing a weighted value of each sensor for the abnormal route patterns for each section may be learned, and the route of the autonomous vehicle is compensated based on the learning result and thus, routes optimized for various driving environments may be provided.

The description above is merely illustrative of the technical idea of the present disclosure, and various modifications and changes may be made by those skilled in the art without departing from the essential characteristics of the present disclosure. Therefore, the exemplary embodiments disclosed in the present disclosure are not intended to limit the technical idea of the present disclosure but to illustrate the present disclosure, and the scope of the technical idea of the present disclosure is not limited by the exemplary embodiments. The scope of the present disclosure should be construed as being covered by the scope of the appended claims, and all technical ideas falling within the scope of the claims should be construed as being included in the scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for compensating for a route of an autonomous vehicle, comprising:
a learning device configured to learn a first route pattern and second route patterns based on a state of each of a plurality of sensors at an arbitrary section and compensated route patterns for each weighted value of each of the plurality of sensors for each of the second route patterns; and
a compensating device configured to:
detect a third route pattern based on a similarity between the second route patterns and a route generated by a route generating device based on a learning result of the learning device;
detect a final compensated route pattern based on a similarity between compensated route patterns that correspond to the third route pattern and the first route pattern; and
transmit a weighted value of each sensor applied to the final compensated route pattern to the route generating device.

2. The device of claim 1, wherein the first route pattern is a route pattern generated when no error occurs in all of the sensors.

3. The device of claim 1, wherein when an error occurs in the at least one of the sensors, the second route patterns are generated for each error occurrence.

4. The device of claim 1, wherein the compensating device is configured to detect the third route pattern based on the similarity between the second route patterns and the route generated by the route generating device in response to determining that the route generated by the route generating device is abnormal.

5. The device of claim 1, wherein the route generating device is configured to generate a route based on the weighted value of each of the plurality of sensors transmitted from the compensating device.

6. The device of claim 1, wherein the first route pattern, the second route patterns, and the compensated route patterns are extracted based on a deep neural network (DNN).

7. A method for compensating for a route of an autonomous vehicle, comprising:
learning, by a processor, a first route pattern and second route patterns based on a state of each of a plurality of sensors at an arbitrary section and compensated route patterns for each weighted value of each of the plurality of sensors for each of the second route patterns;
detecting, by the processor, a third route pattern based on a similarity between the second route patterns and a route generated by a route generating device;
detecting, by the processor, a final compensated route pattern based on a similarity between compensated route patterns that correspond to the third route pattern and the first route pattern; and
transmitting, by the processor, a weighted value of each of the plurality of sensors applied to the final compensated route pattern to the route generating device.

8. The method of claim 7, wherein the first route pattern is a route pattern generated when no error occurred in all of the sensors.

9. The method of claim 7, wherein when an error occurred in the at least one of the sensors, the second route patterns are generated for each error occurrence.

10. The method of claim 7, wherein the detecting of the third route pattern is performed in response to determining that the route generated by the route generating device is abnormal.

11. The method of claim 7, further comprising:
generating, by the route generating device, a route based on the weighted value of each of the plurality of sensors transmitted from the compensating device.

12. The method of claim 7, wherein the first route pattern, the second route patterns, and the compensated route patterns are extracted based on a deep neural network (DNN).

13. A system for compensating for a route of an autonomous vehicle, comprising:
a plurality of sensors configured to collect various sensor data;
a route generating device configured to generate a route of the autonomous vehicle based on the sensor data collected by the plurality of sensors; and
a route compensating device configured to:
learn a first route pattern and second route patterns based on a deep neural network (DNN);
learn compensated route patterns for each weighted value of each of the plurality of sensors for each of the second route patterns; and
compensate the route of the autonomous vehicle based on the learning result.

14. The system of claim 13, wherein the route generating device reflects weight values set by the route compensating device to the sensor data obtained from the plurality of sensors to generate the route.

15. The system of claim 13, wherein the route compensating device includes:
a learning device configured to learn a first route pattern and second route patterns based on a state of each of the plurality of sensors at an arbitrary section and compensated route patterns for each weighted value of each of the plurality of sensors for each of the second route patterns; and
a compensating device configured to:
detect a third route pattern based on a similarity between the second route patterns and a route generated by a route generating device based on the learning result of the learning device;
detect a final compensated route pattern based on a similarity between compensated route patterns that correspond to the third route pattern and the first route pattern; and
transmit a weighted value of each sensor applied to the final compensated route pattern to the route generating device.

16. The system of claim 15, wherein the first route pattern is a route pattern generated when no error occurred in all of the sensors.

17. The system of claim 15, wherein the second route patterns are a route pattern generated when an error occurred in at least one of the sensors.

18. The system of claim 15, wherein the compensating device detects the third route pattern based on the similarity between the second route patterns and the route generated by the route generating device in response to determining that the route generated by the route generating device is abnormal.
